(19) United States
(12) Patent Application Publication
(10) Pub. No.: US 2007/0098520 A1
(43) Pub. Date: May 3, 2007

(54) Bolt that can be pressed into a metal sheet in a torsion-proof and ejection-proof manner

(76) Inventor: Thorsten Schraer, LEMGO (DE)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/596,421

(22) PCT Filed: Jan. 12, 2005
(86) PCT No.: PCT/DE05/00032

§ 371 Date: Jun. 13, 2006

(30) Foreign Application Priority Data
Jan. 13, 2004 (DE) 20 2004 000 463.1

(51) Int. Cl. F16B 37/04

(52) U.S. Cl. 411/179

(57) ABSTRACT

Disclosed is a bolt (10) that can be pressed into a metal sheet in a torsion-proof and ejection-proof manner and comprises a head (12). The side of the head (12) facing the metal sheet after being inserted is provided with radially arranged webs (22) which are pressed in when being inserted into the metal sheet. A cylindrical winding support (14) is disposed in the center of the head (12). Said winding support (14) extends through the metal sheet and protrudes on the other side thereof while being provided with a circumferential annular groove (20) near the side of the head (12) that faces the metal sheet in the set state. The sheet metal material that is displaced during the setting process can be pressed into said annular groove (20). All or part of the side of the head (12) facing the metal sheet is provided with a rubber-elastic sealing material (110).

The present invention relates to a bolt that can be pressed into a metal sheet in a torsion-proof and ejection-proof manner according to DE-Gbm 200 12 097 U1.

Since during the setting of bolts according to this reference, on the one hand, is accompanied by a flowing of the material of the metal sheet, on the other hand, however, a sealing only is consisting of a steel-steel material pairing, the connection between the bolt and the metal sheet according to the prior art is not safely tight against liquid or even gases.

It is therefore the task to be solved by the present invention to improve such a bolt in such a way that after the setting it is positioned in a fluid-- and gas-tight manner.

In this way, according to the invention, for the first time, such a bolt that can be pressed-in could be used in cases where it is necessary that the bolt after the setting is absolutely liquid-tight and gas-tight.

Until now to this end only commercial screws could be used which therefore however in a expensive way singularly had to be welded, wherein during the welding, too, a substantial expenditure with respect to inspection was necessary to ensure that the welding always was gas-tight. Therefore this method was extremely complicated and cost-intensive. According to the invention, this method in a far more simple way can be performed by pressing-in a bolt according to the invention.

The above-defined task therefore is solved by means of a bolt according to the preamble of the enclosed claim 1, wherein the side of the head facing the metal sheet is provided with a rubber-elastic sealing material.

Preferred embodiments can be learned from the enclosed sub-claims, wherein it is especially preferred that the webs themselves are free from the sealing material since in this way a decreasing of the safety against torsion and ejection of the bolt by the covering with the sealing material is avoided.

In the same way, this can be prevented by the sealing material being provided exclusively in the region of the outer rim of the head facing the metal sheet.

In the same way, this further problem can be avoided by the fact that the sealing material exclusively is positioned in an annular groove in the head which is positioned outwardly of the radial extension of the webs but within the outer edge of the head facing the metal sheet.

The present invention, in the following, is more detailly described with respect to the exemplary embodiments shown in the drawings. In the drawings show:

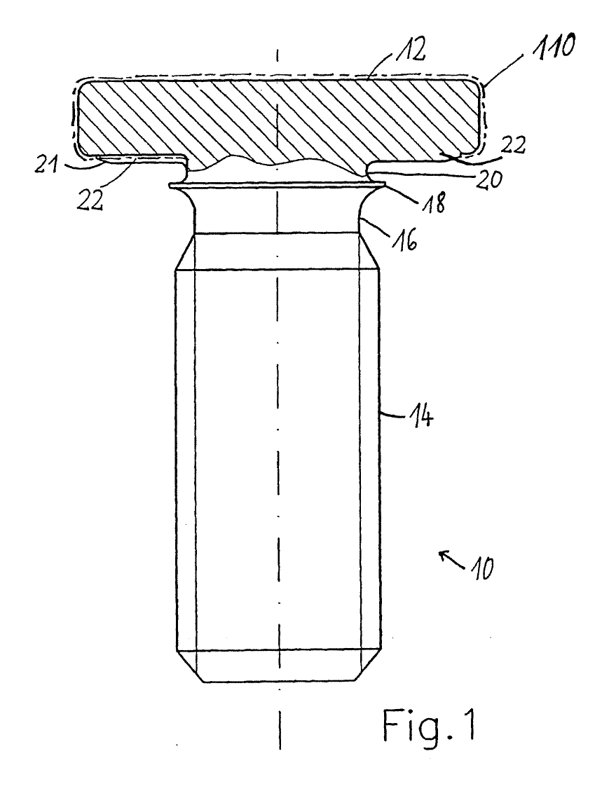

FIG. 1 a bolt according to the invention with a coating of the entire head except the webs in a lateral cross-sectional view;

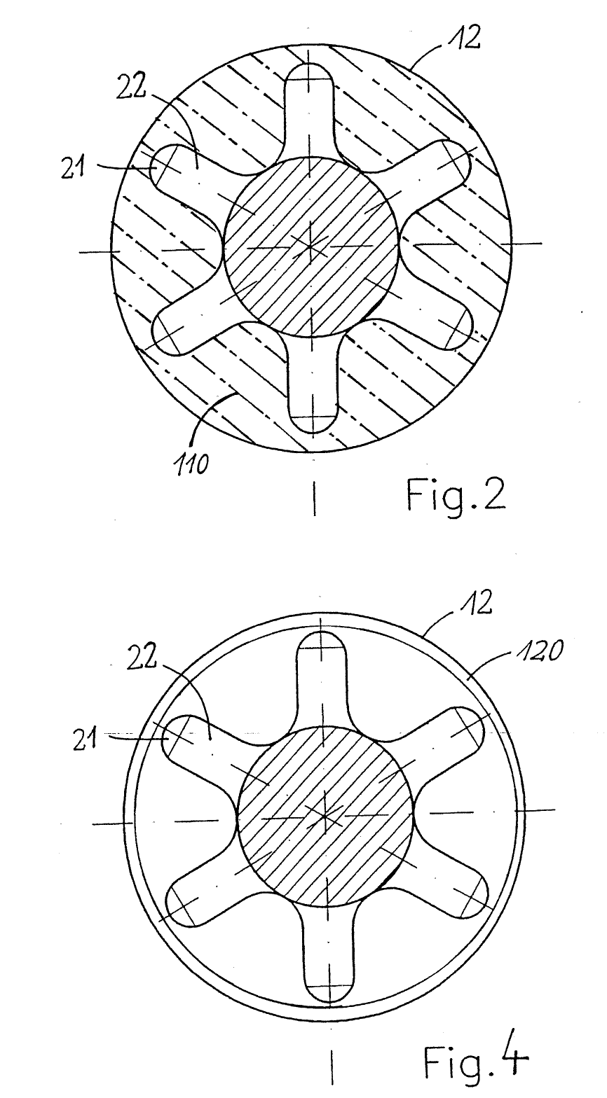

FIG. 2 the head of the bolt according to FIG. 1 from below;

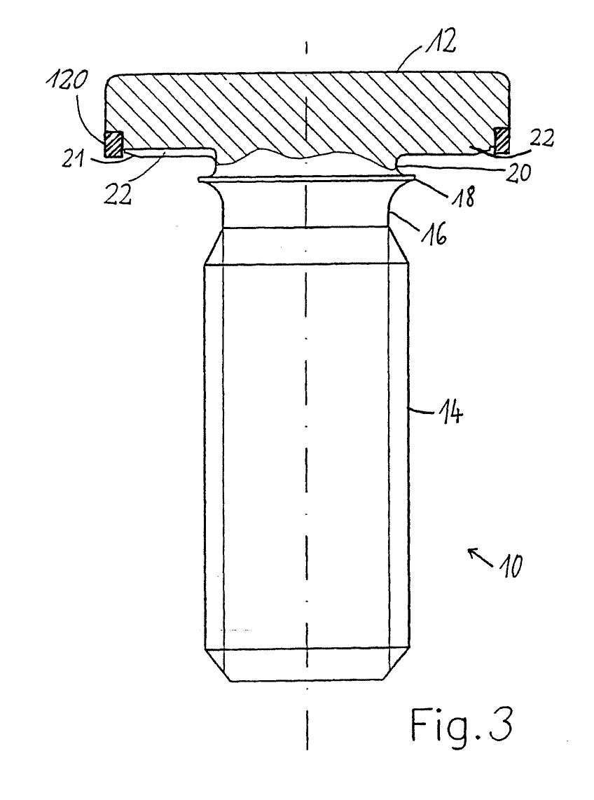

FIG. 3 a bolt according to the invention with the sealing material in the region of the outer edge of the head in a lateral cross-sectional view;

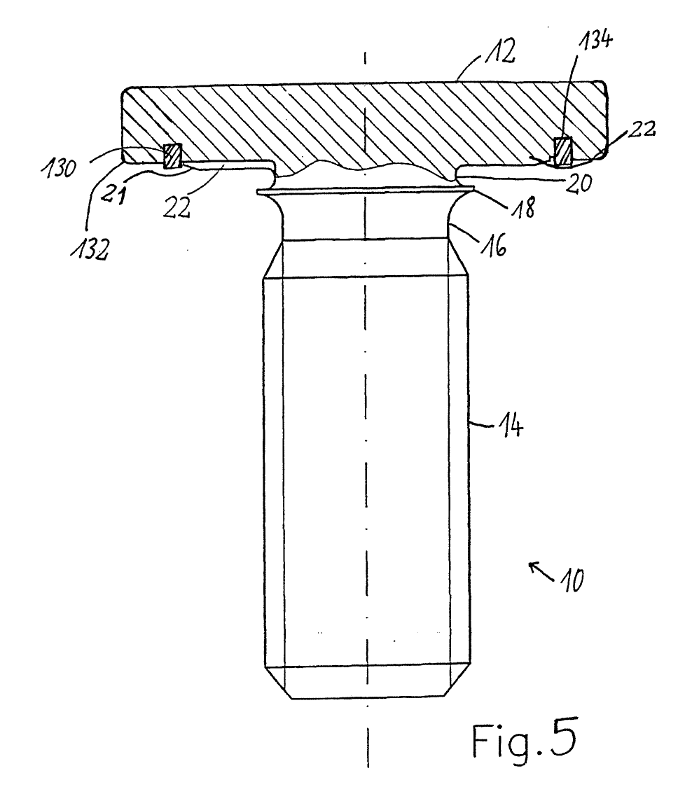

FIG. 4 the bolt of the head according to FIG. 3 from below;

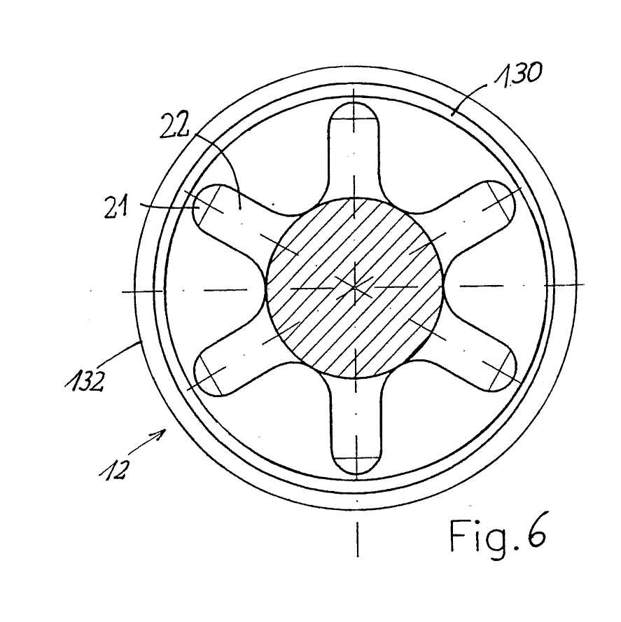

FIG. 5 a further bolt according to the invention in a lateral cross-sectional view; and

FIG. 6 the head of the bolt according to FIG. 5 from below.

As shown in FIG. 1, a bolt 10 according to the invention is consisting of a disk-shaped head 12 and a connected cylindrical winding support 14 having an exterior thread.

Between the thread and the head 12, in the following order a calibration collar 16, an annular projection 18 and an annullar groove 20 having a semi-circular cross-section are provided. On the bottom side of the head 12, which is facing during the setting of the fastener the metal sheet, there are provided radially extending webs 22 having a radial extension in a basically uniform height and which merely in their radially exterior area 21 are flattened.

The head 12 is shown partly in cross-section, wherein on the right hand side the corresponding web 22 is shown in cross-section, too, while the corresponding web 22 on the left hand side is shown in a side view.

According to the invention, such a bolt can be set in a metal sheet in a fluid- and gas-tight manner by coating the head with a rubber-elastic sealing material. The coating can be performed in the most simple way by immersion, wherein the corresponding coating can be extended up to the calibration collar 16. As a coating material in this case preferably epoxy resin is used, for example the product Rimlex® of the ANOCHROME-Group, Great Britain, which can be applied in a liquid state which later is forming a solid elastic sealing material. In such a case, the safety with respect to torsion and ejection of the bolt can be impaired slightly. The coating 110 shown in FIG. 1 therefore is extending only onto the head itself, wherein the webs 22 are kept free from the coating. This, on the one hand, is more difficult to be produced compared with the above-disclosed simple solution according to the invention, on the other hand, is providing for higher mechanical load values of the set bolt.

FIG. 2 is showing the head 12 of the bolt according to FIG. 1 from below. Because of the interrupted cross-hatching, the area provided with the sealing material 110 of the head 12 visible from below clearly can be seen. Equally clearly it can be seen that the webs 22 including their bevels 21 are not covered by the rubber-elastic sealing material.

FIG. 3 is showing a further embodiment of the bolt according to the invention. Same reference numerals are characterising here the same constituents as in FIGS. 1 and 2 and the corresponding description here is not again repeated.

With respect to the bolt showing in FIG. 3 according to the invention in the region of the outer edge of the head 12 facing the metal sheet a circumferential recess is provided being filled with the rubber-elastic sealing material 120. Alternatively a corresponding sealing ring of polyurethane, polyamide, polytetrafluorethylene or polyolefins can be inserted into the recess. This solution has the advantage that the mechanical properties of the set bolt are not at all influenced by the sealing material.

FIG. 4 is showing the head of the bolt of FIG. 3 from below, wherein the position of the annulus 120 of the rubber-elastic sealing material again clearly can be learned.

FIG. 5 is showing a further embodiment of the bolt according to the invention. Here the head 12 is having a slightly larger diameter and radially outwardly of the webs 22 an annular groove 134 is provided in the head 12 which therefore is extending within the outer edge 132 of the head 12 facing the metal sheet. This groove 134 is filled with the sealing material 130 or a corresponding sealing ring of polyurethane, polyamide, polytetrafluorethylene or polyolefins is inserted in the groove 134.

FIG. 6 is showing the head of the bolt of FIG. 5 from below. Here again the extension of the annular groove 134 is obvious.

As a rubber-elastic sealing material 110, 120, 130 here preferably when coating the head epoxy resin is used, wherein in connection with the solutions according to FIGS. 3 or 5 preferably polyurethane, polyamide, polytetrafluorethylene or a mixture of polyolefins is used.

1. Bolt (10) that can be pressed into a metal sheet in a torsion-proof and ejection-proof manner having a head (12) the side of which facing the metal sheet in the set state is having radially extending webs (22) which during the setting are impressed into the metal sheet, wherein in the centre of the head a cylindrical winding support (14) is positioned which is extending through the metal sheet an protrudes on the other side thereof and which is having in vicinity of the side of the head (12) fag the metal sheet a circumferential annular groove (20) into which the sheet metal material that is displaced during the setting process can be pressed, characterised in that the side of the head (12) facing the metal sheet completely or partly is provided with a rubber-elastic sealing material (110; 120; 130).

2. Bolt according to claim 1, characterised in that the webs (22) basically are having a rectangular cross-section with their side walls (24) extending perpendicular to the side of the head (12) facing the metal sheet.

3. Bolt according to claim 1, characterised in that the webs (22) in their radially exterior region are tapering off flatly.

4. Bolt according to claim 1, characterised in that the webs (22) in their radially exterior region (21) are tapering off laterally rounded.

5. Bolt according to claim 1, characterised in that it can be pressed into metal shoots with holes without special additional shapes as collars or the like.

6. Bolt according to claim 1, characterised in that merely the area outwardly of the webs (22) are provided with the rubber-elastic sealing material (110) while the webs (22) themselves are free from the sealing material (110).

7. Bolt according to claim 1, characterised in that the sealing material (120) exclusively is provided in the region of the outer edge of the head (12) facing the metal sheet.

8. Bolt according to claim 1, characterised in that the sealing material (130) exclusively is provided in an annular groove (134) in the head (12) which is positioned outwardly of the radial extension of the webs (22) but within the outer edge (132) of the head (12) facing the metal sheet.

9. Bolt according to claim 1, characterised in that the sealing material (110; 120; 130) is consisting of polyurethane, polyamide, polyolefin, polyteluoretylene or epoxy resin.
